(19) United States
(12) Patent Application Publication
(10) Pub. No.: US 2025/0187286 A1
(43) Pub. Date: Jun. 12, 2025

(54) IMPROVED TAMPING PIN TOOLING DESIGNS

(71) Applicant: Innex Innovative Industries, Rochester, NY (US)

(72) Inventor: Thomas Blaszczykiewicz, Rochester, NY (US)

(21) Appl. No.: 18/971,271

(22) Filed: Dec. 6, 2024

Related U.S. Application Data
(60) Provisional application No. 63/606,882, filed on Dec. 6, 2023.

(51) Int. Cl. B30B 11/04; A61J 3/10

(52) U.S. Cl. CPC B30B 11/04; A61J 3/10

(57) ABSTRACT

Tooling assemblies having a metal portion with a proximal and distal end and a ceramic portion having a proximal and distal end. The proximal end of the ceramic portion being engaged with the distal end of the metal portion by an interference fit. The tooling assemblies may be reconditioned by replacing a worn ceramic portion with a new ceramic portion.

### CROSS REFERENCE TO RELATED APPLICATIONS

This application is related and claims priority to U.S. Provisional Patent Application No. 63/606,882 filed on Dec. 6, 2023, which is incorporated herein by reference.

### FIELD

The claimed technology relates generally to tooling and more particularly to tooling used in the manufacture of pharmaceuticals, nutraceuticals, and other supplements.

### BACKGROUND

One tool of particular utility in the pharmaceutical industry is the compaction die. The compaction die is an isostatic pressing device utilized in the production of tablets utilized in, and not limited to, the following industries: battery, pharmaceuticals, nutraceuticals, cosmetics, confectionary, food, pet food, chlorine and industrial tablets. Such dies are commonly used for tamping down active and non-active ingredients, typically a homogeneous powder mixture, into a capsule container or tablet that is used to produce an oral Pharmaceutica, Nutraceutical or Vitamin), and/or over the counter or prescribed medication in pill or capsule form.

Obtaining the proper dosage in the capsule or tablet is important to ensure the consumer does not receive an overdose or underdose that could have serious health repercussions. Hence, ensuring the capsule is filled properly is desirable. Product sticking to tools or incorrect loading can have unproductive consequences. Capsule packing companies face difficult challenges as the sticking powders are packed with steel tamping pins. The tips of the tamping pin are typically steel which causes a high rate of friction and as a result powders get stuck in the pores of the steel which increases as the steel wears. As the powder sticks to the tamping pin, it creates a problem with trying to obtain the proper dosage leading to variations and high rates of wasted product. Further, it increases the chances that improperly filled capsules will be sold to customers which can cause severe health issues caused by under the over or under dosage factor. There is a need for tamping pins which provide increased antistick and low friction in addition to improved wear properties as well as anti-rust and corrosion resistance.

### SUMMARY

In one aspect a tooling assembly, comprising an elongated base portion having a distal end and a proximal end, the proximal end having an axial opening therein, and an elongated ceramic rod portion having a distal end and a proximal end, the proximal end being inserted into the axial opening in the proximal end of the elongated base portion where the proximal end of the elongated ceramic rod is secured to the proximal end of the elongated base portion by an interference fit. In one example the distal end of the elongated ceramic rod portion is a metal-detectable ceramic tip and the ceramic tip may be configured as a compaction punch for producing pharmacological pill bodies. Optionally, the ceramic tip includes an outer wear layer made from a polymer. Optionally, the elongated base portion is made of a metal such as steel and the elongated ceramic rod portion is selected from the group consisting of alumina, mullite, zirconia, yttria stabilized zirconia (YSZ), combinations thereof. In one example the tooling assembly is a punch in a rig for manufacturing pharmaceutical tablets. In another example at least one respective elongated member further comprises a plurality of metallic particles dispersed therein; wherein the metallic particles are selected from the group consisting of Ni, Fe, Co, permalloy, Mu-metal, and combinations thereof; and wherein the at least one respective elongated member has a high magnetic permeability μ of at least about 2.5×10⁻² H/m with a relative permeability μ/μₒ of at least about 20000. Optionally, the ceramic portion of the punch tooling is metal-detectable.

In another aspect, a method of refurbishing a tooling assembly, comprising the steps of: providing tooling assembly having an elongated base portion having a distal end and a proximal end, the proximal end having an axial opening therein and a first elongated ceramic rod portion having a worn distal end and a proximal end, the proximal end being inserted into the axial opening in the proximal end of the elongated base portion and secured to the proximal end of the elongated base portion; removing the first elongated ceramic rod portion from the elongated base portion; providing a second elongated ceramic rod portion having a distal end and a proximal end; and inserting the proximal end of the second elongated ceramic rod portion into the axial opening of the elongated base portion, where the proximal end of the second elongated ceramic rod is secured to the proximal end of the elongated base portion. In one example, the proximal end of the first and second elongated ceramic rods are secured to the proximal end of the elongated base portion by an interference fit. In another example, the proximal end of the first and second elongated ceramic rods are secured to the proximal end of the elongated base portion by a threaded engagement. Optionally, inserting the proximal end of the second elongated ceramic rod portion into the axial opening of the elongated base portion step is by press fit. In one example, the proximal end of the elongated base portion is heated after removal of the first elongated ceramic rod portion and prior to insertion of the second elongated ceramic rod portion. In one example, the first and second elongated ceramic rod portion are over molded with a polymer wear layer. Optionally, removal of the first elongated ceramic rod portion includes heating the proximal end of the elongated base portion. In another example, the distal end of the elongated ceramic rod portion is a ceramic tip configured as a compaction punch for producing pharmacological pill bodies. In still other examples, the elongated base portion is made of steel and the elongated ceramic rod portions are selected from the group consisting of alumina, mullite, zirconia, yttria stabilized zirconia (YSZ), combinations thereof.

In still another aspect, a tooling assembly having a metallic base portion having a distal end and a proximal end, the distal end being configured for attachment to a press machine and the proximal end having an axial opening therein, and a ceramic rod portion having a distal end and a proximal end, the proximal end being inserted into the axial opening in the proximal end of the elongated base portion, the distal end being a ceramic tip, where the proximal end of the elongated ceramic rod is secured to the proximal end of the elongated base portion by an interference fit. In one example, the press machine produces pharmaceutical pill bodies and the ceramic tip is configured as a compaction punch for producing pharmacological pharmaceutical pill bodies. Optionally, the ceramic tip is made from a metal-detectable ceramic.

### BRIEF DESCRIPTION OF THE DRAWINGS

FIG. 1 is a perspective view of a tooling body according to one example of the disclosed technology.

FIG. 2 is a side view of the tooling body shown in FIG. 1.

FIG. 3 is an exploded view of the tooling body shown in FIG. 2.

FIG. 4 is a partial cross sectional view of the tooling body of FIG. 2 along line 102.

FIG. 5 is a partial cross sectional view of the tooling body of FIG. 3 along line 103.

FIG. 6 is a perspective view of a tooling body according to another example of the disclosed technology.

### DESCRIPTION

For the purposes of promoting an understanding of the principles of the claimed technology and presenting its currently understood best mode of operation, reference will now be made to the embodiments illustrated in the drawings and specific language will be used to describe the same. It will nevertheless be understood that no limitation of the scope of the claimed technology is thereby intended, with such alterations and further modifications in the illustrated device and such further applications of the principles of the claimed technology as illustrated therein being contemplated as would normally occur to one skilled in the art to which the claimed technology relates.

In describing the disclosed technology reference is made to “capsules”. It is understood that the disclosed improved tamping pins may be used in the production of not only capsule but other forms or configurations of medicants such as caplets, pills, tablets, or any other body formed by the compression of one or more ingredients. The following examples and descriptions also refer to the pharmaceutical industry, but it is also understood that the disclosed improved tamping pins may also be used in other industries where a body is formed by the compression of one or more ingredients such as battery, pharmaceuticals, nutraceuticals, cosmetics, confectionary, food, pet food, chlorine, industrial tablets, and the like.

Presently tamping pins are made from some type of steel which is not ideal for packing abrasive, sticky, and/or corrosive ingredients into the capsule. Steel is soft and porous compared to ceramic and steel can oxidize and rust as well. The cell structure of steel is large and gets soiled easily allowing for growth of bacteria which is highly problematic for companies producing capsules. Additionally, when a steel tamping pin is worn it cannot be reused and is disposed of rather than reworked.

The novel tamping pin designs disclosed herein utilizes ceramic, Polytetrafluoroethylene (PTFE) and/or other composite materials that provide improved antistick properties, lower friction, and improved wear properties as well as anti-rust and corrosion resistance over current tamping pin designs using all steel bodies. Steel bodies polished to a surface roughness of 4 Ra typically have a wear resistance better than PTFE but worse than ceramic materials, but they also have a higher coefficient of friction than both PTFE and ceramic materials. PTFE has a lower coefficient of friction but worse wear resistance than both steel and ceramic materials. Depending on the specific ceramic material used they may have coefficients of friction on par with PTFE but wear resistance on par with or better than steel, especially under abrasive and/or corrosive conditions.

In one example an improved tamping pin according to the disclosed technology is a two part body having a first body portion made from steel or other metal and a second tip portion made from a ceramic, composite material, PTFE, or metal having desired tribology properties. The tip portion is removable from the body portion and replaceable with a new and/or reconditioned tip portion so that the tamping pin may be returned to service rather than disposed of like current tamping pin designs.

The materials used for the tip in this particular example, including ceramic, provide desirable tribology, reducing both friction and wear when polished at a 4 Ra or better acting like a lubricated surface. Ceramic does not oxidize or corrode regardless of the conditions under which it is used. This novel tooling significantly reduces the negative effects of sticky and abrasive powders as compared to all steel tooling. This reduces the need for tooling changes, excessive cleaning, line shutdowns, building defective products and ensures safer dosage filling. The improved accuracy and reduced waste also contribute to the advantages of this disclosed technology. Optionally, the ceramic portion of the tooling may be metal-detectable so as to allow for the detection and removal of any portions which fracture off of the main body and potentially contaminating the final pharmaceutical product.

In another example the disclosed tamping pin designs are engineered to be reworked and not simply disposed of like the traditional, one life steel design. The two-piece design is made of a ceramic (or other chosen material) tip and steel housing. When the tip is worn and/or damaged the steel base still has viability and can be reworked. The steel housing at the connection of the ceramic is heated up until the steel expands. The tip is pulled out and replaced by a new ceramic or other type of tip. The tip can be ceramic or another material that provides a reduction in friction, great wear and corrosion resistance and non-rusting such as PTFE, with or without coatings, or special heat treatments. PTFE and plastics can be threaded to the housing while the stainless steel could be heat inducted or threaded and can be replaced on site or returned to manufacturer for reconditioning. A reconditioned tool is typically machined, polished, and returned for reuse by the customer.

Optionally, the disclosed tamping pins may be manufactured with standard ceramic, metal detectable ceramic, carbide, or PTFE (metal detectable or non-metal detectable), or other suitable materials which provide improved wear and friction characteristics over traditional steel tooling. Additional coatings or special heat treatments can also be added to further enhance the tribology of the tip portions.

In one example, the tooling assembly is a compaction punch for use in a die for producing pharmacological pill bodies. The die may be made of steel, ceramic, cermet composite material, or any convenient structural material. The die is a generally hollow cylindrical member sized to cooperate with the punch to compress powder positioned in the die cavity into a green body pill or tablet. In operation, the compaction rod is utilized on a tablet press. The die is filled with powdered pharmaceutical and the punch is engaged to tamp the powder in the die to yield a pharmaceutical green body, after which the punch is removed from the die and the green body tablet is ejected from the compaction die. The parameters of this process are varied (fine-tuned) depending on the equipment and desired finished product.

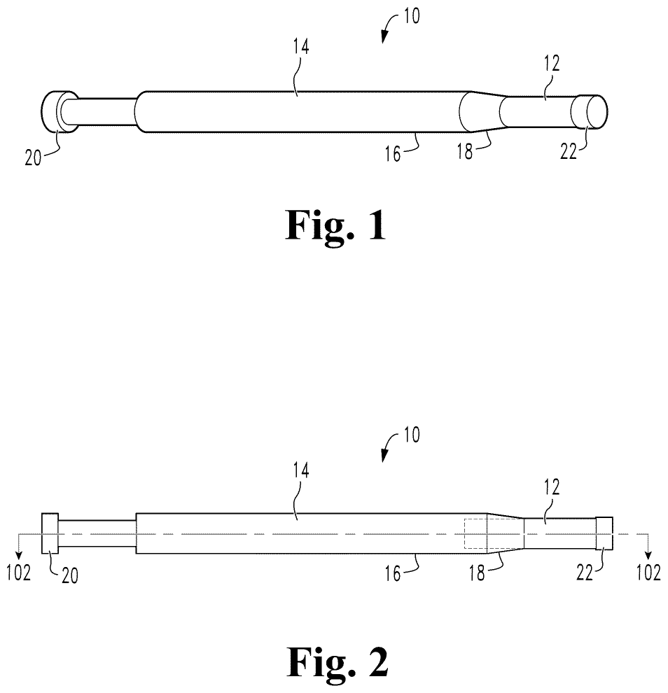

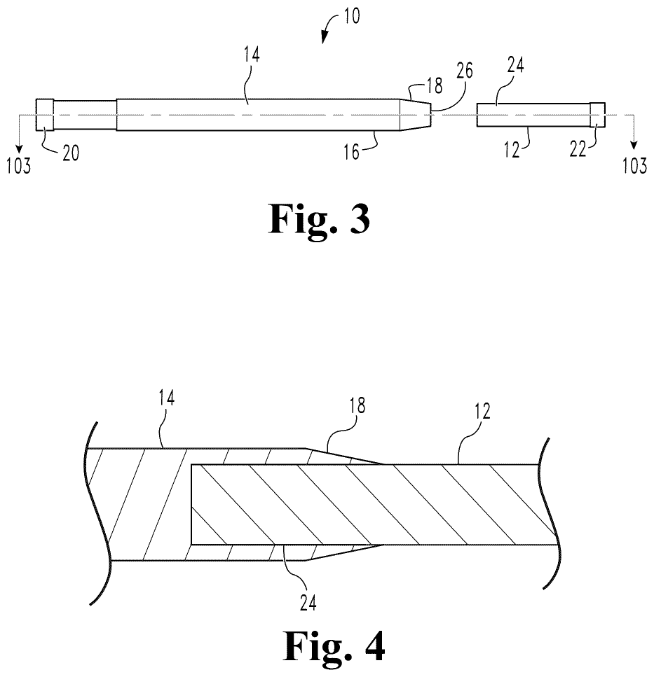

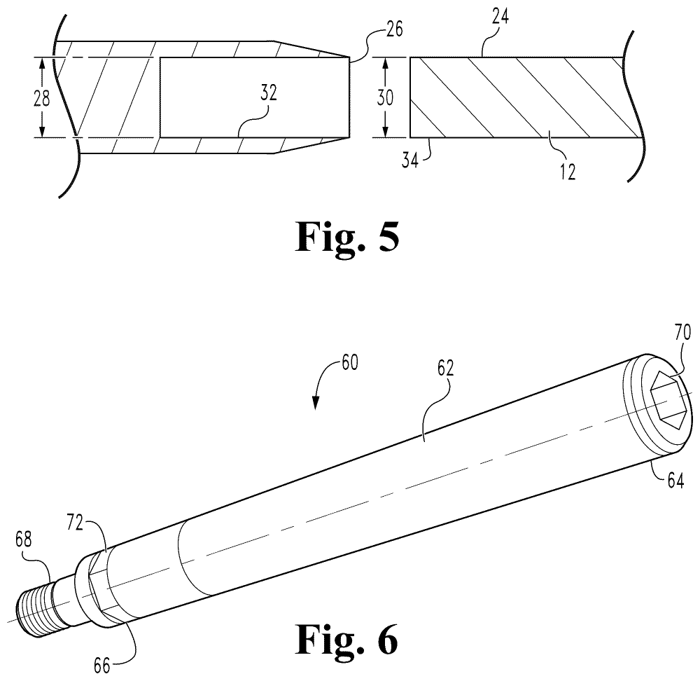

As illustrated in FIGS. 1-5, the disclosed novel technology relates to compressive tooling assembly 10 utilizing a punch or rod portion 12 (typically made from a ceramic material) having a distal end 22 and a proximal end 24. The rod portion 12 may be formed into sintered and densified ceramic bodies that enjoy the physical toughness, strength and wear resistance of ceramics while connected to a metallic base rod, housing, or sleeve portion 14. The base portion 14 has a distal end 20 and a proximal end 16. Optionally, the proximal end 16 may include a contoured or narrow portion 18. The base portion 14 of the tool 10 is typically metal such as steel, Mu metal, manganese ferrite, TiN, silver and the like. The proximal end 24 of the cermet rod portion 12 is press fit to the proximal end 16 of the base portion 14 so as to yield a punch assembly 10 having a ceramic rod/punch tip portion 12 connected to a metal base rod portion 14.

Typically, the ceramic portion 12 is a structural ceramic, such as alumina, mullite, zirconia, yttria stabilized zirconia (YSZ), combinations therefor, or the like. The ceramic portion is formed, such as by any convenient ceramic processing means, sintered, and fired. Optionally, proximal end 24 may include surface features such as grooves or knurling to improve engagement between the ceramic portion 12 and the metal base portion 14. Such features may be formed in situ, or may be machined into the green/sintered/fired ceramic rod portion 12. Typically a portion of the ceramic rod portion 12, particularly the distal end 22, may be polished to reduce friction between the ceramic rod portion 12 and material being compacted when in use. In one example, the ceramic rod portion 12 is polished to at least 4 Ra or better. In this particular example the distal end 22 of the ceramic rod portion 12 is shown as a cylinder, but in other examples the distal end 22 may have any desired shape and/or have any desired feature(s) required by a particular application.

In some examples, the ceramic rod portion 12 may include a metallic phase such as Ni, Fe, Co, permalloy, Mu-metal, and combinations thereof, dispersed therein. The metallic phase may be introduced in oxide form for reduction to metallic form during processing, to avoid mixing issues arising from significant density differences as well as metallic species chemically interacting with oxide species at elevated temperatures. Alternately, some or all of the metallic phase component may be introduced as metallic species. The metallic phase may be an alloy, and the alloy may be introduced as metal alloy particles, particles of oxidized alloy, or as oxides of the constituent metals for reduction and subsequent alloying of the resulting metals. The metallic phase typically has a high magnetic permeability μ of at least about 1×10−4 H/m, more typically μ being at least about 1×10−3 H/m, still more typically μ being at least about 1×10−2 H/m, and yet more typically μ being about 5×10−2 H/m. The metallic phase typically has a relative permeability μ/μo of at least about 100, more typically at least about 1000, still more typically of at least about 10,000, and yet more typically of at least about 20,000, and in some cases, μ/μo may exceed 50,000 or more.

The base portion distal end 20 is shown having a cylindrical shape in this particular example. In other examples the base portion distal end 20 may have other shapes/configurations/features as desired depending on the particular application. For example, the base portion distal end 20 may be threaded, tapered, straight, have one or more locking features depending on the machine in which it is to be used. Optionally, a portion of the base portion 14 and/or distal end 20 may include surface features/shapes (such as a hex shape configured for use with a wrench) which allow for easier mounting/removal of a tooling assembly 10 from a machine.

An alternative example tooling assembly 60 base portion 62 is shown in FIG. 6. In this particular example, the base portion 62 has a proximal end 64 and a distal end 66. The proximal end 64 includes an opening 70 having a hexagonal rather than a round shape. In still other examples the opening may have other desired shapes. The distal end 66 includes a threaded attachment feature 68 as well as a hexagonal portion 72 configured for engaging a wrench or other tool to assist in attachment/removal of the tooling assembly 60 from a machine.

The base portion proximal end 16 includes an opening 26 centered on the central axis A of the tooling assembly 10 and having a diameter 28 sized and configured to produce an interference fit with the cermet rod portion proximal end 24 having a diameter 30. The exact size of these diameters 28, 30 may be determined by the particular application of a specific tooling assembly 10. Optionally, the surface 34 of the cermet rod portion proximal end 24 and/or the interior surface 32 of the opening 26 may include surface features such as grooves or knurling to help secure the cermet rod portion proximal end 24 to the base portion proximal end 16.

When assembling a tooling assembly 10 the cermet rod portion proximal end 24 may be press fit into the base portion proximal end 16 (i.e., force method). Alternatively, the metallic base portion proximal end 16 may be heated and/or the cermet rod portion proximal end 24 cooled and the two ends fitted together then allowed to return to their starting temperature to form an interference fit (i.e., thermal method). In another example, a combination of methods may be used. For example, the metallic base portion proximal end 16 may be heated and then the cermet rod portion proximal end 24 press fit into the metallic base portion proximal end 16.

When the cermet rod portion 12 of a tooling assembly 10 becomes worn and/or damaged the tooling assembly may be removed from the machine in which it is used and then reconditioned so the tooling assembly 10 may be reused. In one example of reconditioning/refurbishing a tooling assembly 10, the cermet rod portion 12 is removed from engagement with the base portion 14, preferably in a manner that does minimal to no damage to the base portion 14. For example, the cermet rod portion 12 may be destructively removed by shattering, breaking, drilling, or otherwise damaging the cermet rod portion 12 so that it may be removed from the base portion 14. Optionally, the base portion 14 may be heated such that the diameter 28 of the opening 26 increases sufficiently to allow the cermet rod portion 12 to be removed. Once the worn cermet rod portion 12 is removed the base portion 14 may be inspected for damage, polished, cleaned, have any damage or wear repaired, then prepared for attachment to a new cermet rod portion 12. The new cermet rod portion 12 may be attached to the reconditioned base portion 14 using any of the previously described methods (thermal, force, or combinations thereof). The refurbished tooling assembly 10 may then be returned to service thereby saving time and money over having to produce an entirely new tooling assembly.

In another example the rod portion is molded over with a polymer or polymer composite layer forming a wear sleeve to further protect the rod portion (which is made from metal, ceramic, or composite material). The rod portion may include radials or grooves pressed thereinto, allowing the wear sleeve to fill such grooves or radials and hug the rod portion body, thus holding the rod portion body tightly. Optionally, the proximal end of the base portion and the proximal end of the rod portion are threaded such that the rod portion may be threadably engaged with the base portion rather than press fit as previously described. Optionally, a glue or other adhesive may be used to help secure the rod body portion to the base portion, either alone or in combination with the press fit or threaded engagement examples.

In such examples where the rod portion include a wear layer the rod portion may be removed from the base portion when the wear layer is reduced below a predetermined thickness and/or after a certain number of hours of use. Once removed the remaining portion of the wear layer may be removed from the rod portion (using heat, mechanical means, or the like), the rod portion inspected for damage/wear, and a new wear layer applied to the rod portion. The reconditioned rod portion may then be reattached to the base portion and the reconditioned tooling returned to service.

While the claimed technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the claimed technology are desired to be protected.

What is claimed is:

1. A tooling assembly, comprising:
an elongated base portion having a distal end and a proximal end, the proximal end having an axial opening therein; and
an elongated ceramic rod portion having a distal end and a proximal end, the proximal end being inserted into the axial opening in the proximal end of the elongated base portion;
wherein the proximal end of the elongated ceramic rod is secured to the proximal end of the elongated base portion by an interference fit.

2. The tooling assembly of claim 1, wherein the distal end of the elongated ceramic rod portion is a metal-detectable ceramic tip.

3. The tooling assembly of claim 2 wherein the ceramic tip is configured as a compaction punch for producing pharmacological pill bodies.

4. The tooling assembly of claim 2, wherein the ceramic tip includes a polymer wear layer.

5. The tooling assembly of claim 1 wherein the elongated ceramic rod portion is selected from the group consisting of alumina, mullite, zirconia, yttria stabilized zirconia (YSZ), combinations thereof.

6. The tooling assembly of claim 1 wherein the tooling assembly is a punch in a rig for manufacturing pharmaceutical tablets.

7. The tooling assembly of claim 1 wherein at least one respective elongated member further comprises a plurality of metallic particles dispersed therein; wherein the metallic particles are selected from the group consisting of Ni, Fe, Co, permalloy, Mu-metal, and combinations thereof; and wherein the at least one respective elongated member has a high magnetic permeability μ of at least about 2.5×10⁻² H/m with a relative permeability μ/μₒ f at least about 20000.

8. A method of refurbishing a tooling assembly, comprising the steps of:
a) providing tooling assembly having:
an elongated base portion having a distal end and a proximal end, the proximal end having an axial opening therein;
a first elongated ceramic rod portion having a worn distal end and a proximal end, the proximal end being inserted into the axial opening in the proximal end of the elongated base portion;
b) removing the first elongated ceramic rod portion from the elongated base portion;
c) providing a second elongated ceramic rod portion having a distal end and a proximal end; and
d) inserting the proximal end of the second elongated ceramic rod portion into the axial opening of the elongated base portion.

9. The method of claim 8, wherein the proximal ends of the first and second elongated ceramic rod portion are secured to proximal end of the elongated base portion by an interference fit.

10. The method of claim 8, wherein the proximal ends of the first and second elongated ceramic rod portion are secured to proximal end of the elongated base portion by a threaded engagement.

11. The method of claim 8, further comprising:
between step c) and step d) the proximal end of the elongated base portion is heated.

12. The method of claim 8, wherein step b) includes heating the proximal end of the elongated base portion.

13. The method of claim 8, wherein the distal end of the elongated ceramic rod portion is a ceramic tip configured as a compaction punch for producing pharmacological pill bodies.

14. The method of claim 8, wherein the first elongated ceramic rod is destroyed during step b).

15. The method of claim 8, wherein the first and second elongated ceramic rod portion are over molded with a polymer wear layer.

16. The method of claim 8, wherein the elongated ceramic rod portions are selected from the group consisting of alumina, mullite, zirconia, yttria stabilized zirconia (YSZ), combinations thereof.

17. A tooling assembly, comprising:
a metallic base portion having a distal end and a proximal end, the distal end being configured for attachment to a press machine and the proximal end having an axial opening therein; and
a ceramic rod portion having a distal end and a proximal end, the proximal end being inserted into the axial opening in the proximal end of the elongated base portion, the distal end being a ceramic tip;
wherein the proximal end of the elongated ceramic rod is secured to the proximal end of the elongated base portion by an interference fit.

18. The tooling assembly of claim 17, wherein the press machine produces pharmaceutical pill bodies.

19. The tooling assembly of claim 17, wherein the ceramic tip is configured as a compaction punch for producing pharmacological pharmaceutical pill bodies.

20. The tooling assembly of claim 19, wherein the ceramic tip is a metal-detectable ceramic.
